(19) United States
(12) Patent Application Publication
(10) Pub. No.: US 2026/0005826 A1
(43) Pub. Date: Jan. 1, 2026

(54) RANDOM ACCESS CHANNEL OCCASION AND UPLINK CHANNEL OCCASION MAPPING FOR SUB-BAND FULL DUPLEX

(71) Applicant: QUALCOMM Incorporated, San Diego, CA (US)

(72) Inventors: Ahmed Attia ABOTABL, San Diego, CA (US); Abdelrahman Mohamed Ahmed Mohamed IBRAHIM, San Diego, CA (US); Muhammad Sayed Khairy ABDELGHAFFAR, San Jose, CA (US)

(21) Appl. No.: 18/759,343

(22) Filed: Jun. 28, 2024

(51) Int. Cl. H04L 5/14; H04W 74/00; H04W 74/0836

(52) U.S. Cl. CPC H04L 5/14; H04W 74/004; H04W 74/0836

(57) ABSTRACT

Methods, systems, and devices for wireless communication are described. A UE may be configured to interpret random access channel occasions (ROs), physical uplink shared channel occasions (POs), or both, scheduled during an uplink sub-band of a downlink sub-band full duplex (SBFD) slot to be valid for preamble transmissions or payload transmissions. For example, one or more POs may be scheduled during an uplink sub-band of an SBFD slot for payload transmissions by UEs operating using SBFD techniques. Additionally, or alternatively, one or more ROs may be scheduled during an uplink sub-band of an SBFD slot for preamble transmissions by UEs operating using SBFD techniques. For example, some ROs, POs, or both, may be valid for all UEs, while other ROs, POs, or both, scheduled during uplink sub-bands of SBFD slots may be valid for UEs operating using the SBFD techniques, and preamble mappings may be performed accordingly.

### FIELD OF TECHNOLOGY

The following relates to wireless communication, including random access channel (RACH) occasion (RO) and uplink channel occasion mapping for sub-band full duplex (SBFD).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

Some wireless multiple-access communications system may include one or more base stations, each supporting wireless communication for communication devices, which may be known as user equipment (UE). In some examples, UEs may initiate communications with a network entity using random access procedures, such as four-step random access channel (RACH) or two-step RACH.

### SUMMARY

The systems, methods, and devices of this disclosure each have several innovative aspects, no single one of which is solely responsible for the desirable attributes disclosed herein.

A method for wireless communication by an apparatus is described. The method may include receiving a random access channel (RACH) configuration that indicates a set of random access channel occasions (ROs) and a set of physical uplink shared channel occasions (POs), transmitting a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink sub-band full duplex (SBFD) slot, and receiving a second message associated with the two-step random access procedure based on the transmitted first message.

An apparatus for wireless communication is described. The apparatus may include one or more memories storing processor executable code, and one or more processors coupled with the one or more memories. The one or more processors may individually or collectively be operable to execute the code to cause the apparatus to receive a RACH configuration that indicates a set of ROs and a set of POs, transmit a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot, and receive a second message associated with the two-step random access procedure based on the transmitted first message.

Another apparatus for wireless communication is described. The apparatus may include means for receiving a RACH configuration that indicates a set of ROs and a set of POs, means for transmitting a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot, and means for receiving a second message associated with the two-step random access procedure based on the transmitted first message.

A non-transitory computer-readable medium storing code for wireless communication is described. The code may include instructions executable by one or more processors to receive a RACH configuration that indicates a set of ROs and a set of POs, transmit a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot, and receive a second message associated with the two-step random access procedure based on the transmitted first message.

In some examples of the method, apparatus, and non-transitory computer-readable medium described herein, the RACH configuration schedules the set of ROs on a first uplink slot, a first subset of the set of POs on a second uplink slot, and a second subset of the set of POs on the uplink sub-band of the downlink SBFD slot.

Some examples of the method, apparatus, and non-transitory computer-readable medium described herein may further include operations, features, means, or instructions for performing the preamble transmission during a first RO of the set of ROs, where the first RO corresponds to the first uplink slot and performing the payload transmission during a first PO of the second subset of the set of POs, where the first PO corresponds to the uplink sub-band of the downlink SBFD slot.

Some examples of the method, apparatus, and non-transitory computer-readable medium described herein may further include operations, features, means, or instructions for selecting a preamble from a set of preambles corresponding to the first RO, where a first subset of the set of preambles corresponds to the first subset of the set of POs, and a second subset of the set of preambles corresponds to the second subset of the set of POs and performing the preamble transmission during the first RO based on the selected preamble.

Some examples of the method, apparatus, and non-transitory computer-readable medium described herein may further include operations, features, means, or instructions for selecting a preamble from a set of preambles corresponding to the first RO, where each preamble of the set of preambles corresponds a respective first PO of the first subset of the set of POs and a second PO of the second subset of the set of POs, performing the preamble transmission during a first RO, and performing the payload transmission during a first PO of the first subset of the set of POs or during a second PO of the second subset of the set of POs based on selecting the preamble.

In some examples of the method, apparatus, and non-transitory computer-readable medium described herein, the RACH configuration schedules a first subset of the set of ROs on a first uplink slot, a second subset of the set of ROs on the uplink sub-band of the downlink SBFD slot, and the set of POs on a second uplink slot.

Some examples of the method, apparatus, and non-transitory computer-readable medium described herein may further include operations, features, means, or instructions for performing the preamble transmission during a first RO of the second subset of the set of ROs, where the first RO corresponds to the uplink sub-band of the downlink SBFD slot and performing the payload transmission during a first PO of the set of POs during the second uplink slot.

Some examples of the method, apparatus, and non-transitory computer-readable medium described herein may further include operations, features, means, or instructions for selecting a preamble from a set of preambles corresponding to the first RO, where each preamble of the set of preambles corresponds to a PO of the set of POs, performing the preamble transmission during the first RO based on the selected preamble, and where performing the payload transmission during the first PO may be based on the preamble transmission.

Some examples of the method, apparatus, and non-transitory computer-readable medium described herein may further include operations, features, means, or instructions for receiving an indication of one or more reference signals corresponding to second subset of the set of ROs, the one or more reference signals indicating a mapping between the second subset of the set of ROs and the set of POs, where performing the preamble transmission may be based on the mapping.

In some examples of the method, apparatus, and non-transitory computer-readable medium described herein, the RACH configuration schedules a first subset of the set of ROs on a first uplink slot, a second subset of the set of ROs on a first uplink sub-band of a first downlink SBFD slot, a first subset of the set of POs on a second uplink slot, and a second subset of the set of POs on a second uplink sub-band of a second downlink SBFD slot.

In some examples of the method, apparatus, and non-transitory computer-readable medium described herein, the RACH configuration indicates a first mapping between the first subset of the set of ROs and the first subset of the set of POs, and a second mapping between the second subset of the set of ROs and the second subset of the set of POs.

Some examples of the method, apparatus, and non-transitory computer-readable medium described herein may further include operations, features, means, or instructions for performing the preamble transmission within the first uplink sub-band of the first downlink SBFD slot and performing the payload transmission within the second uplink sub-band of the second downlink SBFD slot based on the second mapping.

In some examples of the method, apparatus, and non-transitory computer-readable medium described herein, the RACH configuration indicates a mapping between the set of ROs and the set of POs.

Some examples of the method, apparatus, and non-transitory computer-readable medium described herein may further include operations, features, means, or instructions for performing the preamble transmission during the first uplink slot and performing the payload transmission within the second uplink sub-band of the second downlink SBFD slot based on the mapping.

Some examples of the method, apparatus, and non-transitory computer-readable medium described herein may further include operations, features, means, or instructions for performing the preamble transmission within the first uplink sub-band of the first downlink SBFD slot and performing the payload transmission during the second uplink slot based on the mapping.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports SBFD for random access and uplink channel occasions in accordance with one or more aspects of the present disclosure.

FIG. 2 shows an example of a process flow that supports SBFD for random access and uplink channel occasions in accordance with one or more aspects of the present disclosure.

FIG. 3 through 5 shows examples of timing diagrams that support SBFD for random access and uplink channel occasions in accordance with one or more aspects of the present disclosure.

FIGS. 6 and 7 show block diagrams of devices that support SBFD for random access and uplink channel occasions in accordance with one or more aspects of the present disclosure.

FIG. 8 shows a block diagram of a communications manager that supports SBFD for random access and uplink channel occasions in accordance with one or more aspects of the present disclosure.

FIG. 9 shows a diagram of a system including a device that supports SBFD for random access and uplink channel occasions in accordance with one or more aspects of the present disclosure.

FIGS. 10 and 11 show flowcharts illustrating methods that support SBFD for random access and uplink channel occasions in accordance with one or more aspects of the present disclosure.

### DETAILED DESCRIPTION

A user equipment (UE) may perform a random access procedure, for example, such as a two-step random access channel (RACH) procedure to establish communications with a network entity. The two-step RACH procedure may involve a first message (e.g., MsgA) transmitted by the UE, which may include a preamble transmission during a RACH occasion (RO) and a payload transmission during a physical uplink shared channel (PUSCH) occasion (PO) (e.g., or payload occasion), and a second message (e.g., MsgB) from the network entity in response to the first message to establish the communications. In some cases, one or more of the UE or the network entity may support sub-band full duplex (SBFD), in which one or more SBFD slots (e.g., of a component carrier) may be configured with both uplink resources (e.g., one or more uplink sub-bands) and downlink resources (e.g., one or more downlink sub-bands). As such, SBFD techniques may reduce latency between communications, as the UE may have more opportunities to transmit or receive signaling via the SBFD slots.

In some cases, some UEs in a wireless communications system may not be configured to operate using SBFD techniques. As such, these UEs may not be able to detect or use uplink sub-bands within a downlink SBFD slot, and may not be able to perform the preamble transmission or the payload transmission if a corresponding RO or PO is scheduled within an uplink sub-band of a downlink SBFD slot. As such, a network entity may refrain from scheduling ROs or POs within downlink SBFD slots, but this may increase latency for UEs that are configured to operate using SBFD techniques and would otherwise be able to perform preamble transmissions or payload transmissions for two-step RACH via uplink sub-bands of downlink SBFD slots.

In accordance with examples as described herein, a UE may be configured to interpret ROs, POs, or both, scheduled during an uplink sub-band of a downlink SBFD slot to be valid for preamble transmissions or payload transmissions. For example, one or more POs may be scheduled during an uplink sub-band of an SBFD slot for payload transmissions by UEs operating using SBFD techniques. Additionally, or alternatively, one or more ROs may be scheduled during an uplink sub-band of an SBFD slot for preamble transmissions by UEs operating using SBFD techniques. For example, some ROs, POs, or both, may be valid for all UEs, while other ROs, POs, or both, scheduled during uplink sub-bands of SBFD slots may be valid for UEs operating using the SBFD techniques. As each preamble transmission via an RO for two-step RACH may map to a corresponding PO, techniques for mapping preambles to POs for UEs operating using SBFD techniques and for UEs not using SBFD techniques are additionally described, which may maintain consistency between all UEs and the receiving network entity.

Aspects of the disclosure are initially described in the context of wireless communications systems. Aspects of the disclosure are additionally descried with reference to process flows and timing diagrams. Aspects of the disclosure are further illustrated by and described with reference to apparatus diagrams, system diagrams, and flowcharts that relate to SBFD for random access and uplink channel occasions.

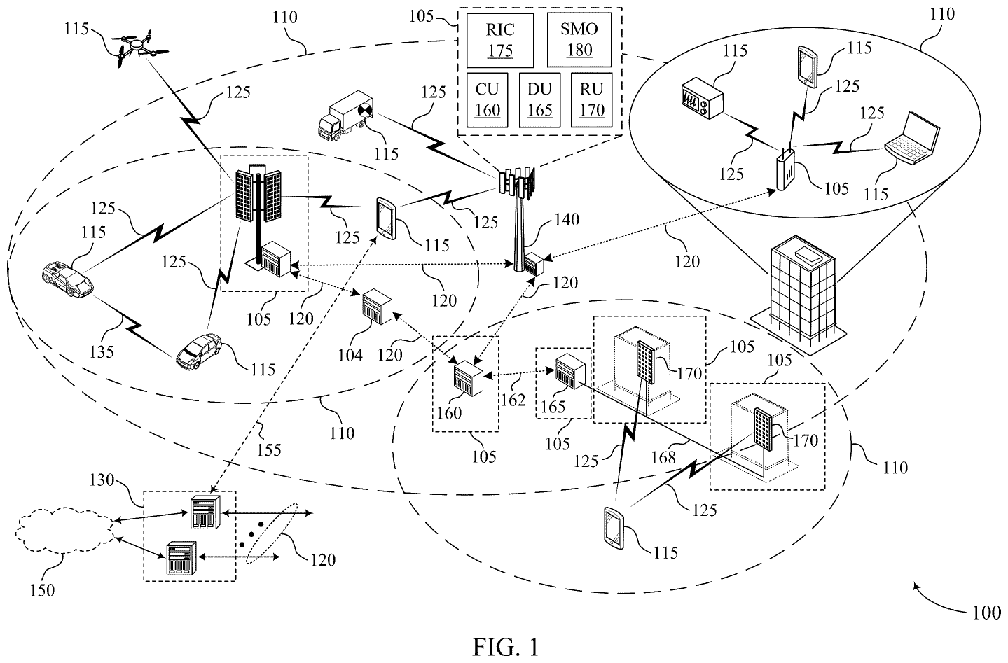

FIG. 1 shows an example of a wireless communications system 100 that supports SBFD for random access and uplink channel occasions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may perform two-step RACH procedure to establish communications with a network entity 105. The two-step RACH procedure may involve a first message (e.g., MsgA) transmitted by the UE 115, which may include a preamble transmission during an RO and a payload transmission during a PO, and a second message (e.g., MsgB) from the network entity 105 in response to the first message to establish the communications. Additionally, some wireless communications systems may implement SBFD, in which one or more SBFD slots (e.g., of a component carrier) may be configured with both uplink resources (e.g., one or more uplink sub-bands) and downlink resources (e.g., one or more downlink sub-bands). For example, a downlink SBFD slot may include one or more uplink sub-bands (e.g., in addition to downlink resources), and an uplink SBFD slot may include one or more downlink sub-bands (e.g., in addition to uplink resources). As such, SBFD techniques may reduce latency between communications, as a UE 115 may have more opportunities to transmit or receive signaling via the SBFD slots.

In some cases, some UEs 115 in a wireless communications system may not be configured to operate using SBFD techniques. As such, these UEs 115 may not be able to detect or use uplink sub-bands within a downlink SBFD slot, and may not be able to perform the preamble transmission or the payload transmission if a corresponding RO or PO is scheduled within an uplink sub-band of a downlink SBFD slot. As such, a network entity 105 may refrain from scheduling ROs or POs within downlink SBFD slots, but this may increase latency for UEs 115 that are configured to operate using SBFD techniques and would otherwise be able to perform preamble transmissions or payload transmissions for two-step RACH via uplink sub-bands of downlink SBFD slots.

In accordance with examples as described herein, a UE 115 may be configured to interpret ROs, POs, or both, scheduled during an uplink sub-band of a downlink SBFD slot to be valid for preamble transmissions or payload transmissions. For example, one or more POs may be scheduled during an uplink sub-band of an SBFD slot for payload transmissions by UEs 115 operating using SBFD techniques. Additionally, or alternatively, one or more ROs may be scheduled during an uplink sub-band of an SBFD slot for preamble transmissions by UEs 115 operating using SBFD techniques. For example, some ROs, POs, or both, may be valid for all UEs, while other ROs, POs, or both, scheduled during uplink sub-bands of SBFD slots may be valid for UEs operating using the SBFD techniques. As each preamble transmission via an RO for two-step RACH may map to a corresponding PO, techniques for mapping preambles to POs for UEs operating using SBFD techniques and for UEs 115 not using SBFD techniques are additionally described, which may maintain consistency between all UEs 115 and the receiving network entity 105.

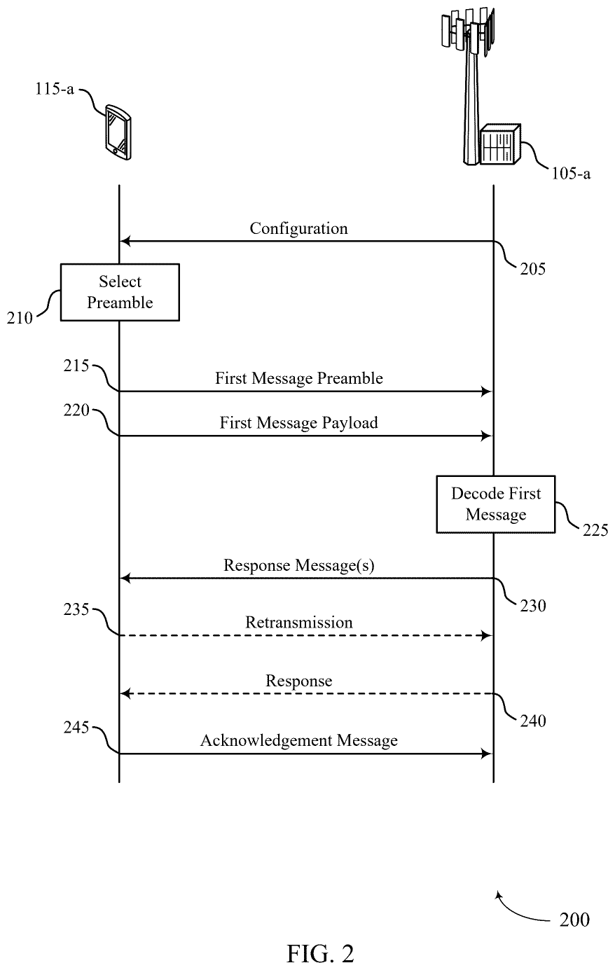

FIG. 2 shows an example of a process flow 200 that supports SBFD for random access and uplink channel occasions in accordance with one or more aspects of the present disclosure. The process flow 200 illustrates communications between a UE 115-a and a network entity 105-a, which may be examples of corresponding devices as described herein, with reference to FIG. 1. In some cases, one or more steps of the process flow 200 may be omitted or performed in a different order than shown, or new steps not shown may be added.

At 205, the UE 115-a may receive a message indicating a configuration (e.g., a RACH configuration) from the network entity 105-a. The configuration may indicate a set of ROs, a set of POs, or both, for transmission of a preamble portion and a payload portion of a first message (e.g., a message A, MsgA) by the UE 115-a. In some examples, the configuration may indicate a mapping between ROs of the set of ROs and POs of the set of POs, which may be used by the network entity 105-a to identify which messages were transmitted by the UE 115-a (e.g., associating a preamble transmission received during a first RO to a payload transmission received during a corresponding first PO).

In accordance with examples as described herein, the configuration may schedule at least some of the set of ROs, the set of POs, or both, for an uplink portion of a downlink SBFD slot. For example, the configuration may schedule the set of ROs on a first uplink slot, a first subset of the set of POs on a second uplink slot, and a second subset of the set of POs on an uplink sub-band of a downlink SBFD slot. Additionally, or alternatively, the configuration may schedule a first subset of the set of ROs on a first uplink slot, a second subset of the set of ROs on an uplink sub-band of a downlink SBFD slot, and the set of POs on a second uplink slot. In some other examples, the configuration may schedule a first subset of the set of ROs on a first uplink slot, a second subset of the set of ROs on a first uplink sub-band of a first downlink SBFD slot, a first subset of the set of POs on a second uplink slot, and a second subset of the set of POs on a second uplink sub-band of a second downlink SBFD slot.

In some cases, the configuration may indicate different mappings between ROs and POs for UEs 115 operating using SBFD techniques. For example, the configuration may indicate a first mapping between a subset of ROs scheduled on uplink slots (e.g., non-SBFD slots, TDD slots) and a subset of POs scheduling on uplink slots (e.g., non-SBFD slots, TDD slots), and a second mapping between a remaining subset of ROs scheduled on an uplink sub-band of a downlink SBFD slot and a remaining subset of POs scheduled in an uplink sub-band of a downlink SBFD slot. Additionally, or alternatively, the configuration may indicate a mapping between ROs scheduling on uplink slots and POs scheduled on uplink sub-bands of downlink SBFD slots, for example, to the UE 115-a (e.g., and other UEs 115 operating according to SBFD techniques).

At 210, the UE 115-a may select a preamble. In some examples, the UE 115-a may be configured with a set of preambles (e.g., 64 preambles), which may map to one or more POs. For example, a preamble message may allow the network entity 105-a to identify a corresponding payload message received during a subsequent PO. In some examples, each preamble may correspond to a PO, a demodulation reference signal (DMRS) sequence, a port for transmission of the payload during the corresponding PO, or a combination thereof. Additionally, or alternatively, each RO corresponding to a preamble may be associated with a beam direction, and each corresponding PO may be associated with the same beam direction, facilitating transmission by the UE 115-a and reception by the network entity 105-a.

At 215, the UE 115-a may perform a preamble transmission for the first message based on selecting the preamble. For example, the UE 115-a may transmit the preamble transmission (e.g., an indication of the selected preamble, a corresponding synchronization signal block) via a physical RACH (PRACH). The UE 115-a may perform the preamble transmission during a first RO of the set of ROs. In some examples, the first RO may be on an uplink slot (e.g., a TDD slot, a non-SBFD slot). Alternatively, the first RO may be on an uplink sub-band of an SBFD slot. In some examples, the preamble transmission may have one or more parameters based on the selected preamble (e.g., beam direction, or other parameters).

At 220, the UE 115-b may perform a payload transmission for the first message. For example, the payload transmission may be or include a PUSCH message. In some examples, the payload transmission may be based on the selected preamble. For example, the payload transmission may be performed during a first PO of the set of POs that is based on the selected preamble, and the preamble may map the first RO used for the preamble transmission to the first PO (e.g., indicated or corresponding to the selected preamble). For example, the first PO may be on an uplink slot (e.g., a TDD slot, a non-SBFD slot) or an SBFD slot in accordance with the selected preamble. Additionally, or alternatively, the payload transmission may have one or more parameters that are based on the selected preamble, such as a beam direction, a DMRS sequence, a port, or a combination thereof.

At 225, the network entity 105-a may decode the first message based on receiving the preamble transmission, the payload transmission, or both. In some examples, the network entity 105-a may successfully decode the preamble transmission and the payload transmission. In some other examples, the network entity 105-a may successfully decode the preamble transmission but not the payload transmission, and the network entity 105-a may transmit a response message accordingly.

For example, at 230, the network entity 105-a may transmit one or more response messages. In some examples, the network entity 105-a may transmit a second message (e.g., a message B, MsgB) based on successfully decoding the preamble transmission and the payload transmission. In some cases, the second message may include a downlink control message (e.g., via a physical downlink control channel (PDCCH)) and a downlink data message (e.g., via a physical downlink shared channel (PDSCH)). In some examples, the control message may be or include an identifier to enable communications by the UE 115-a with the network entity 105-a (e.g., a radio network temporary identifier (RNTI), such as a cell RNTI (C-RNTI) or a msgB-RNTI). In some examples, the downlink data message may be or include a successful random access response message (e.g., SuccessRAR).

In some other examples, the network entity 105-a may transmit the second message based on decoding the preamble transmission, but not the payload transmission, successfully. For example, the second message may include the downlink control message, which may include a msgB-RNTI. Additionally, or alternatively, the network entity 105-a may transmit the downlink data message that may be or include a fallback indication (e.g., a fallback random access response message, FallbackRAR), which may indicate the UE 115-a to return to using a four step RACH procedure for communications with the network entity 105-a.

At 235, the UE 115-a may transmit a retransmission based on receiving the fallback indication from the network entity 105-a. For example, the UE 115-a may transmit a retransmission of (e.g., or a message including at least similar information, such as the payload, as) the payload transmission for the first message.

At 240, the network entity 105-a may transmit a response based on receiving the retransmission from the UE 115-a. In some examples, the response may a downlink control message (e.g., via a PDCCH) and a downlink data message (e.g., via a PDSCH). In some examples, the control message may be or include an identifier to enable communications by the UE 115-a with the network entity 105-a (e.g., an RNTI, such as a C-RNTI).

At 245, the UE 115-a may transmit an acknowledgment message (e.g., via a physical uplink control channel (PUCCH)). In some examples, the acknowledgment message may be transmitted based on the UE 115-a successfully decoding the downlink data message from the network entity 105-a, the UE 115-a determining to have a valid timing advance, PUCCH resources, and timings, or a combination thereof. In some examples, the acknowledgment message may be an example of a HARQ feedback, such as a positive acknowledgment (ACK) if the UE 115-a successfully decoded the downlink data message, has valid timing advance, PUCCH resources, and PUCCH timings, or a combination thereof, or a negative acknowledgment (NACK) otherwise.

By enabling UEs 115 that can operate using SBFD techniques to transmit preamble transmissions, payload transmissions, or both via downlink SBFD slots, the UEs 115 may have additional opportunities for transmissions, which may reduce transmission latencies. Additionally, UEs that do not operate using SBFD techniques may benefit, as ROs, POs, or both on non-SBFD slots may experience less conflicting traffic from UEs using SBFD techniques, which may be using ROs and POs on SBFD slots.

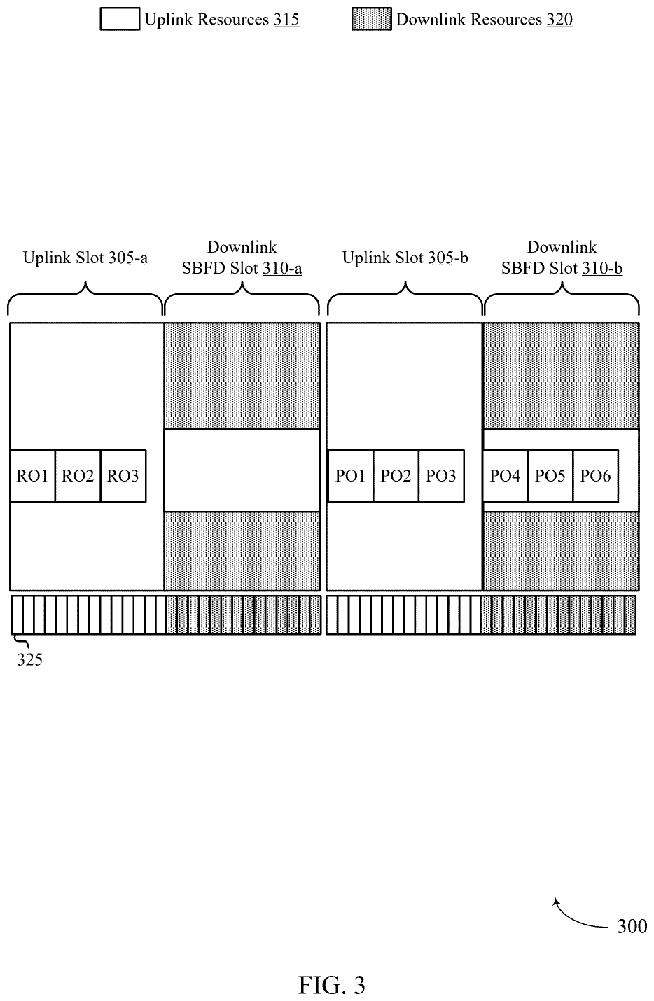

FIG. 3 shows an example of a timing diagram 300 that supports SBFD for random access and uplink channel occasions in accordance with one or more aspects of the present disclosure. The timing diagram 300 may illustrate the configuration of resources for two-step RACH in accordance with SBFD techniques, as described herein with reference to FIGS. 1 and 2, and may be implemented by a UE 115 or a network entity 105 as described herein.

The timing diagram 300 may include uplink slots 305 (e.g., TDD slots, non-SBFD slots) and downlink SBFD slots 310, each of which may include one or more symbols 325. For example, the timing diagram 300 may include an uplink slot 305-a, a downlink SBFD slot 310-a, an uplink slot 305-b, and a downlink SBFD slot 310-b. The uplink slots 305 may include uplink resources 315, while the downlink SBFD slots 310 may include downlink resources 320 as well as uplink resources 315. For example, the downlink slots 310 may include an uplink sub-band that may be used for uplink transmissions by UEs 115 configured to operate using SBFD techniques.

In some examples, a UE 115 may be configured with a set of ROs and a set of POs with a configuration that enables POs to be valid in SBFD slots 310, as described herein. For example, the UE 115 may be configured with an RO1, and RO2, and an RO3, which may be scheduled for the uplink slot 305-a. Additionally, the UE 115 may be configured with a PO1, a PO2, and a PO3 scheduled for the uplink slot 305-b, and a PO4, a PO5, and PO6 scheduled for an uplink sub-band of the downlink SBFD slot 310-b. The quantities of ROs and POs illustrated by the timing diagram 300 are exemplary, and different quantities of ROs, POs, or both may be configured to the UE 115.

In some cases, the PO4, the PO5, and the PO6 scheduled for the downlink SBFD slot 310-b may be valid for UEs 115 operating in accordance with SBFD techniques. In some examples, the PO4, PO5, and PO6 may be scheduled so as to not be overlapping with a guard-band of the downlink SBFD slot 310-b or within downlink resources 320 of the downlink SBFD slot 310-b, and the UE 115 may not expect any POs to be scheduled as such. Alternatively, one or more of the POs scheduled for the downlink SBFD slot 310-b may be configured to overlap with a guard band of the downlink SBFD slot 310-b or the downlink resources 320 of the downlink SBFD slot 310-b. In some cases, the UE 115-a may consider these POs scheduled overlapping with the guard band or the downlink resources of the downlink SBFD slot 310-b as invalid.

In some examples, the preambles corresponding to the RO1, the RO2, and the RO3 may have a first mapping to a first subset of the POs (e.g., the PO1, the PO2, and the PO3), and a second mapping to a second subset of the POs (e.g., the PO4, the PO5, and the PO6). For example, each preamble corresponding to the RO1 may have a first mapping to the PO1 and a second mapping to the PO4. Similarly, each preamble corresponding to the RO2 may have a first mapping to the PO2 and a second mapping to the PO5, and each preamble corresponding to the RO3 may have a first mapping to the PO3 and a second mapping to the PO6. In some cases, the second mapping for each preamble may be used by UEs 115 operating using SBFD techniques.

In some cases, a UE 115 operating using SBFD techniques may be configured with a set of preambles, and the UE 115 may map one or more preambles to each valid PO in the uplink slot 305-b and the downlink SBFD slot 310-d. Additionally, or alternatively, the UE 115 may map a subset of the set preambles to POs scheduled for the downlink SBFD slot 310-b. For example, UEs 115 not operating using SBFD techniques may map a first and second preamble to the PO1, a third and fourth preamble to the PO2, and a fifth and sixth preamble to the PO3. The UE 115 operating using SBFD techniques may map the first preamble to the PO1, the second preamble to the PO4, the third preamble to the PO2, the fourth preamble to the PO5, the fifth preamble to the PO3, and the sixth preamble to the PO6. As such, the subset of preambles mapped to POs scheduled for the uplink slot 305-b may be consistent with UEs not operating according to SBFD techniques, which may maintain consistent synchronization signal block indexes. While six preambles are used for exemplary purposes, different quantities of preambles are possible.

Accordingly, a UE 115 may perform payload transmissions via POs scheduling on SBFD slots 310, thereby increasing the opportunities for transmissions, which may potentially reduce transmission latencies.

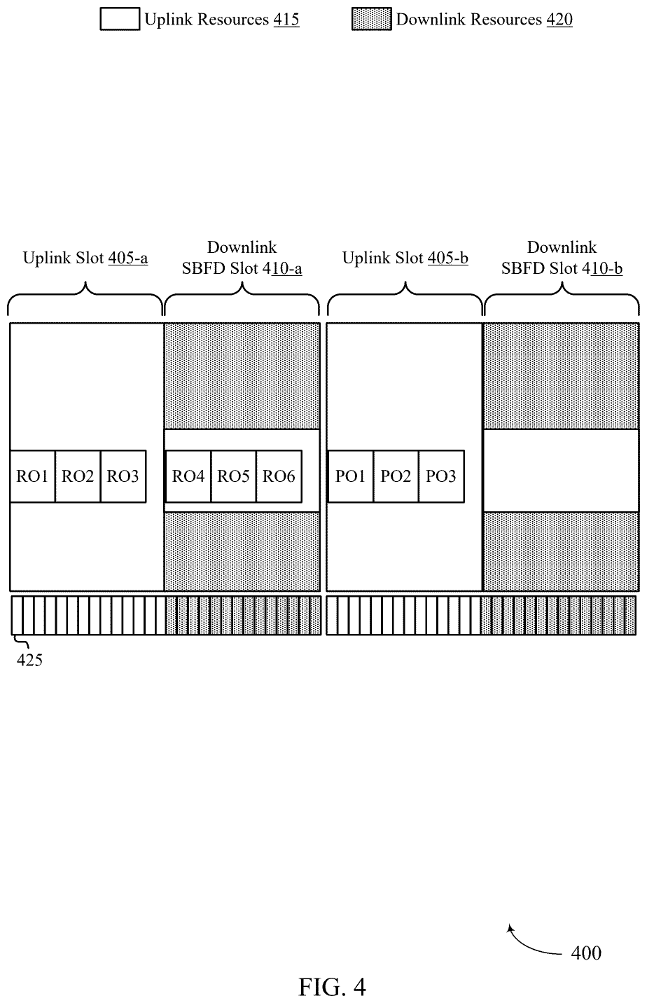

FIG. 4 shows an example of a timing diagram 400 that supports SBFD for random access and uplink channel occasions in accordance with one or more aspects of the present disclosure. The timing diagram 400 may illustrate the configuration of resources for two-step RACH in accordance with SBFD techniques, as described herein with reference to FIGS. 1 through 3, and may be implemented by a UE 115 or a network entity 105 as described herein.

The timing diagram 400 may include uplink slots 405 (e.g., TDD slots, non-SBFD slots) and downlink SBFD slots 410, each of which may include one or more symbols 425. For example, the timing diagram 400 may include an uplink slot 405-a, a downlink SBFD slot 410-a, an uplink slot 405-b, and a downlink SBFD slot 410-b. The uplink slots 405 may include uplink resources 415, while the downlink SBFD slots 410 may include downlink resources 420 as well as uplink resources 415. For example, the downlink SBFD slots 410 may include an uplink sub-band that may be used for uplink transmissions by UEs configured to operate using SBFD techniques.

In some examples, a UE 115 may be configured with a set of ROs and a set of POs with a configuration that enables ROs to be valid in downlink SBFD slots 410, as described herein. For example, the UE 115 may be configured with an RO1, and RO2, and an RO3, which may be scheduled for the uplink slot 405-a, and an RO4, an RO5, and an RO6 scheduled for an uplink sub-band of the downlink SBFD slot 410-a. Additionally, the UE 115 may be configured with a PO1, a PO2, and a PO3 scheduled for the uplink slot 405-b. The quantities of ROs and POs illustrated by the timing diagram 400 are exemplary, and different quantities of ROs, POs, or both may be configured to the UE 115.

In some examples, the preambles corresponding to ROs scheduled for the downlink SBFD slot 410-a may map to POs in the uplink slot 405-b in a same manner as preambles corresponding to ROs scheduled for the uplink slot 405-a. For example, a first preamble (e.g., a synchronization signal block 0) transmitted via the RO1 may map to the PO1 (e.g., may indicate a payload transmission to be transmitted via the PO1), and the first preamble transmitted via the RO4 may similarly map to the PO1. Additionally, or alternatively, the preambles for the ROs in the downlink SBFD slot 410-a may be consistent with preambles for the ROs in the uplink slots 405-a. For instance, if a first preamble for the RO1 maps to the PO1, then the first preamble for the RO4, the RO5, and the RO6 may each map to the PO1.

In some other examples, the preambles corresponding to ROs scheduled for the downlink SBFD slot 410-a may map to POs in the uplink slot 405-b differently from preambles corresponding to ROs scheduled for the uplink slot 405-a. For example, one or more DMRS sequences may be indicated (e.g., by a configuration, from a network entity 105) for the preambles corresponding to the ROs scheduled for the downlink SBFD slot 410-a, and the DMRS sequences may be used for mapping to the POs in the uplink slot 405-b. Additionally, or alternatively, the mapping may be independent of the POs.

In some other cases, there may be no mapping between the ROs scheduled for the downlink SBFD slot 410-a and any POs. In these cases, if a UE 115 performs a preamble transmission via the RO4, the RO5, or the RO6, the UE 115 may perform the payload transmission using a four-step RACH procedure (e.g., or a similar procedure), rather than using two-step RACH. For example, the UE 115 may wait for a response to the preamble transmission from a network entity 105, and perform the payload transmission in accordance with the response.

Accordingly, a UE 115 may perform preamble transmissions via ROs scheduled on downlink SBFD slots 410, thereby increasing the opportunities for transmissions, which may potentially reduce transmission latencies, among other benefits.

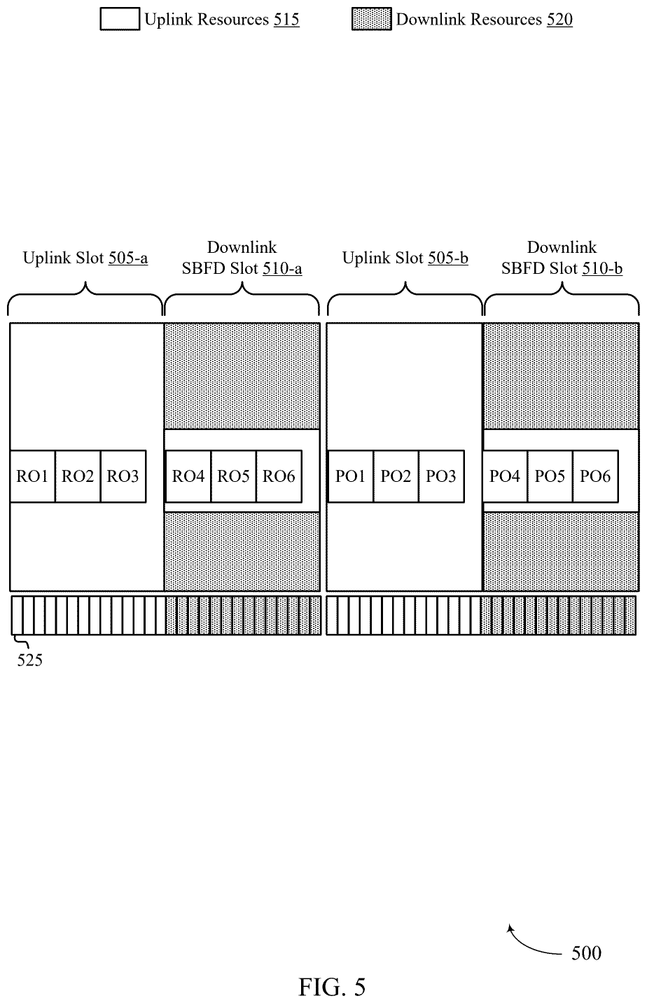

FIG. 5 shows an example of a timing diagram 500 that supports SBFD for random access and uplink channel occasions in accordance with one or more aspects of the present disclosure. The timing diagram 500 may illustrate the configuration of resources for two-step RACH in accordance with SBFD techniques, as described herein with reference to FIGS. 1 through 4, and may be implemented by a UE 115 or a network entity 105 as described herein.

The timing diagram 500 may include uplink slots 505 (e.g., TDD slots, non-SBFD slots) and downlink SBFD slots 510, each of which may include one or more symbols 525. For example, the timing diagram 500 may include an uplink slot 505-a, a downlink SBFD slot 510-a, an uplink slot 505-b, and a downlink SBFD slot 510-b. The uplink slots 505 may include uplink resources 515, while the downlink SBFD slots 510 may include downlink resources 520 as well as uplink resources 515. For example, the downlink SBFD slots 510 may include an uplink sub-band that may be used for uplink transmissions by UEs configured to operate using SBFD techniques.

In some examples, a UE 115 may be configured with a set of ROs and a set of POs with a configuration that enables both ROs and POs to be valid in SBFD slots 510, as described herein. For example, the UE 115 may be configured with an RO1, and RO2, and an RO3, which may be scheduled for the uplink slot 505-a, and an RO4, an RO5, and an RO6 scheduled for an uplink sub-band of the downlink SBFD slot 510-a. Additionally, the UE 115 may be configured with a PO1, a PO2, and a PO3 scheduled for the uplink slot 405-b, and a PO3, a PO4, and a PO6 scheduled for an uplink sub-band of the downlink SBFD slot 510-b. The quantities of ROs and POs illustrated by the timing diagram 500 are exemplary, and different quantities of ROs, POs, or both may be configured to the UE 115.

In some examples, the preambles corresponding to the RO1, the RO2, and the RO3 may have a first mapping to a first subset of the POs (e.g., the PO1, the PO2, and the PO3), and a second mapping to a second subset of the POs (e.g., the PO4, the PO5, and the PO6). For example, each preamble corresponding to the RO1 may have a first mapping to the PO1 and a second mapping to the PO4. Similarly, the RO4, the RO25, and the RO6 may also have a first mapping to the first subset of the POs (e.g., the PO1, the PO2, and the PO3), and a second mapping to the second subset of the POs (e.g., the PO4, the PO5, and the PO6).

Additionally, or alternatively, each of the RO1, the RO2, the RO3, the RO4, the RO5, and the RO6 may be considered one set of ROs, and may each have preambles mapping to both the POs scheduled for the uplink slot 505-b and the POs scheduled for the uplink sub-band of the downlink SBFD slot 510-b. Additionally, or alternatively, each of the PO1, the PO2, the PO3, the PO4, the PO5, and the PO6 may be considered on set of POs, and the mapping may be performed accordingly. The mappings may support consistent mappings for UEs 115 that are not using SBFD techniques.

In some examples, preambles corresponding to the ROs scheduled for the uplink slot 505-a (e.g., the RO1, the RO2, and the RO3) may map to POs scheduled for the uplink slot 505-b (e.g., the PO1, the PO2, and the PO3), while preambles corresponding to the ROs scheduled for the downlink SBFD slot 510-a (e.g., the RO4, the RO5, and the RO6) may map to POs scheduled for the downlink SBFD slot 510-b (e.g., the PO4, the PO5, and the PO6). Additionally, or alternatively, each RO may map (e.g., using one or more corresponding preambles) to each PO, regardless of whether the RO or the PO are scheduled for a downlink SBFD slot 510.

Accordingly, a UE 115 may perform preamble transmissions via ROs scheduled on SBFD slots 510, payload transmissions via POs scheduled on SBFD slots 510, or both, thereby increasing the opportunities for transmissions, which may potentially reduce transmission latencies, among other benefits.

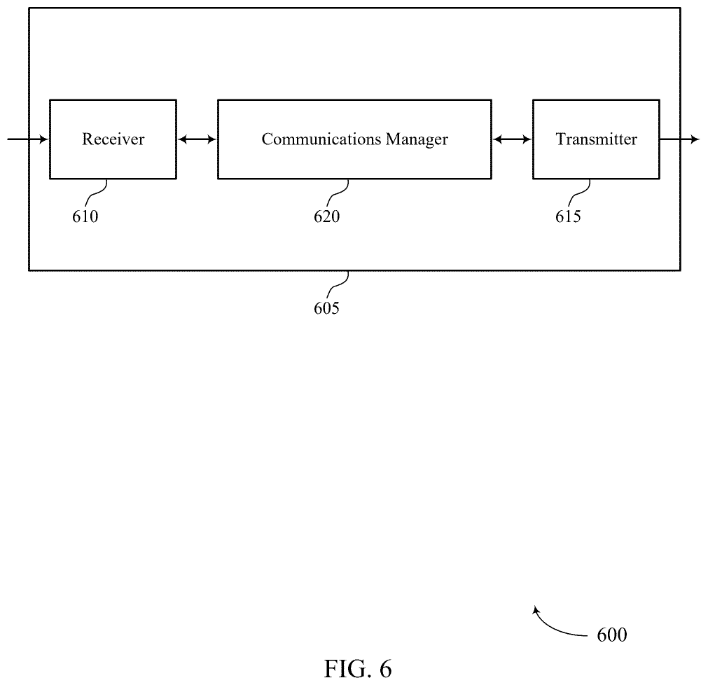

FIG. 6 shows a block diagram 600 of a device 605 that supports SBFD for random access and uplink channel occasions in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to SBFD for random access and uplink channel occasions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SBFD for random access and uplink channel occasions). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of SBFD for random access and uplink channel occasions as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving a RACH configuration that indicates a set of ROs and a set of POs. The communications manager 620 is capable of, configured to, or operable to support a means for transmitting a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot. The communications manager 620 is capable of, configured to, or operable to support a means for receiving a second message associated with the two-step random access procedure based on the transmitted first message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for performing two-step RACH procedures via occasions scheduled for SBFD slots, thereby improving communication efficiency and reducing potential latencies.

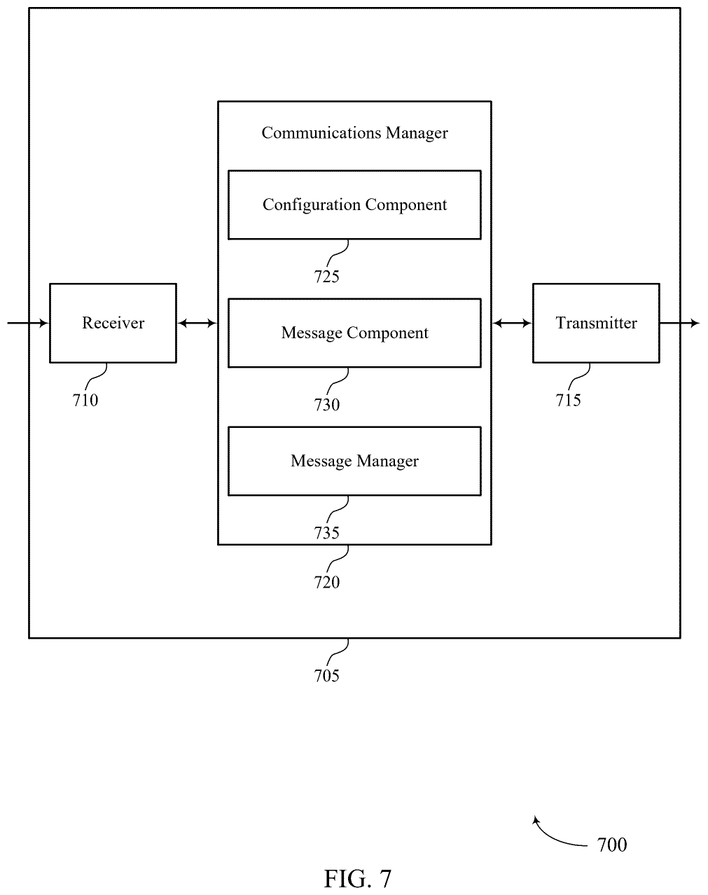

FIG. 7 shows a block diagram 700 of a device 705 that supports SBFD for random access and uplink channel occasions in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to SBFD for random access and uplink channel occasions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SBFD for random access and uplink channel occasions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of SBFD for random access and uplink channel occasions as described herein. For example, the communications manager 720 may include a configuration component 725, a message component 730, a message manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The configuration component 725 is capable of, configured to, or operable to support a means for receiving a RACH configuration that indicates a set of ROs and a set of POs. The message component 730 is capable of, configured to, or operable to support a means for transmitting a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot. The message manager 735 is capable of, configured to, or operable to support a means for receiving a second message associated with the two-step random access procedure based on the transmitted first message.

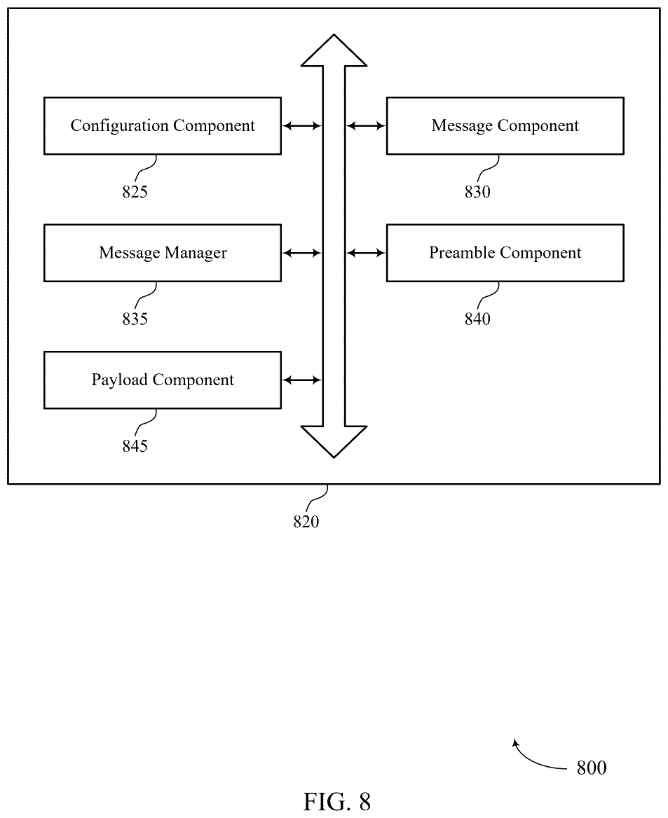

FIG. 8 shows a block diagram 800 of a communications manager 820 that supports SBFD for random access and uplink channel occasions in accordance with one or more aspects of the present disclosure. The communications manager 820 may be an example of aspects of a communications manager 620, a communications manager 720, or both, as described herein. The communications manager 820, or various components thereof, may be an example of means for performing various aspects of SBFD for random access and uplink channel occasions as described herein. For example, the communications manager 820 may include a configuration component 825, a message component 830, a message manager 835, a preamble component 840, a payload component 845, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The configuration component 825 is capable of, configured to, or operable to support a means for receiving a RACH configuration that indicates a set of ROs and a set of POs. The message component 830 is capable of, configured to, or operable to support a means for transmitting a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot. The message manager 835 is capable of, configured to, or operable to support a means for receiving a second message associated with the two-step random access procedure based on the transmitted first message.

In some examples, the RACH configuration schedules the set of ROs on a first uplink slot, a first subset of the set of POs on a second uplink slot, and a second subset of the set of POs on the uplink sub-band of the downlink SBFD slot.

In some examples, the preamble component 840 is capable of, configured to, or operable to support a means for performing the preamble transmission during a first RO of the set of ROs, where the first RO corresponds to the first uplink slot. In some examples, the payload component 845 is capable of, configured to, or operable to support a means for performing the payload transmission during a first PO of the second subset of the set of POs, where the first PO corresponds to the uplink sub-band of the downlink SBFD slot.

In some examples, the preamble component 840 is capable of, configured to, or operable to support a means for selecting a preamble from a set of preambles corresponding to the first RO, where a first subset of the set of preambles corresponds to the first subset of the set of POs, and a second subset of the set of preambles corresponds to the second subset of the set of POs. In some examples, the preamble component 840 is capable of, configured to, or operable to support a means for performing the preamble transmission during the first RO based on the selected preamble.

In some examples, the preamble component 840 is capable of, configured to, or operable to support a means for selecting a preamble from a set of preambles corresponding to the first RO, where each preamble of the set of preambles corresponds a respective first PO of the first subset of the set of POs and a second PO of the second subset of the set of POs. In some examples, the preamble component 840 is capable of, configured to, or operable to support a means for performing the preamble transmission during a first RO. In some examples, the payload component 845 is capable of, configured to, or operable to support a means for performing the payload transmission during a first PO of the first subset of the set of POs or during a second PO of the second subset of the set of POs based on selecting the preamble.

In some examples, the RACH configuration schedules a first subset of the set of ROs on a first uplink slot, a second subset of the set of ROs on the uplink sub-band of the downlink SBFD slot, and the set of POs on a second uplink slot.

In some examples, the preamble component 840 is capable of, configured to, or operable to support a means for performing the preamble transmission during a first RO of the second subset of the set of ROs, where the first RO corresponds to the uplink sub-band of the downlink SBFD slot. In some examples, the payload component 845 is capable of, configured to, or operable to support a means for performing the payload transmission during a first PO of the set of POs during the second uplink slot.

In some examples, the preamble component 840 is capable of, configured to, or operable to support a means for selecting a preamble from a set of preambles corresponding to the first RO, where each preamble of the set of preambles corresponds to a PO of the set of POs. In some examples, the preamble component 840 is capable of, configured to, or operable to support a means for performing the preamble transmission during the first RO based on the selected preamble. In some examples, the payload component 845 is capable of, configured to, or operable to support a means for performing the payload transmission during the first PO is based on the preamble transmission.

In some examples, the message manager 835 is capable of, configured to, or operable to support a means for receiving an indication of one or more reference signals corresponding to second subset of the set of ROs, the one or more reference signals indicating a mapping between the second subset of the set of ROs and the set of POs, where performing the preamble transmission is based on the mapping.

In some examples, the RACH configuration schedules a first subset of the set of ROs on a first uplink slot, a second subset of the set of ROs on a first uplink sub-band of a first downlink SBFD slot, a first subset of the set of POs on a second uplink slot, and a second subset of the set of POs on a second uplink sub-band of a second downlink SBFD slot.

In some examples, the RACH configuration indicates a first mapping between the first subset of the set of ROs and the first subset of the set of POs, and a second mapping between the second subset of the set of ROs and the second subset of the set of POs.

In some examples, the preamble component 840 is capable of, configured to, or operable to support a means for performing the preamble transmission within the first uplink sub-band of the first downlink SBFD slot. In some examples, the payload component 845 is capable of, configured to, or operable to support a means for performing the payload transmission within the second uplink sub-band of the second downlink SBFD slot based on the second mapping.

In some examples, the RACH configuration indicates a mapping between the set of ROs and the set of POs.

In some examples, the preamble component 840 is capable of, configured to, or operable to support a means for performing the preamble transmission during the first uplink slot. In some examples, the payload component 845 is capable of, configured to, or operable to support a means for performing the payload transmission within the second uplink sub-band of the second downlink SBFD slot based on the mapping.

In some examples, the preamble component 840 is capable of, configured to, or operable to support a means for performing the preamble transmission within the first uplink sub-band of the first downlink SBFD slot. In some examples, the payload component 845 is capable of, configured to, or operable to support a means for performing the payload transmission during the second uplink slot based on the mapping.

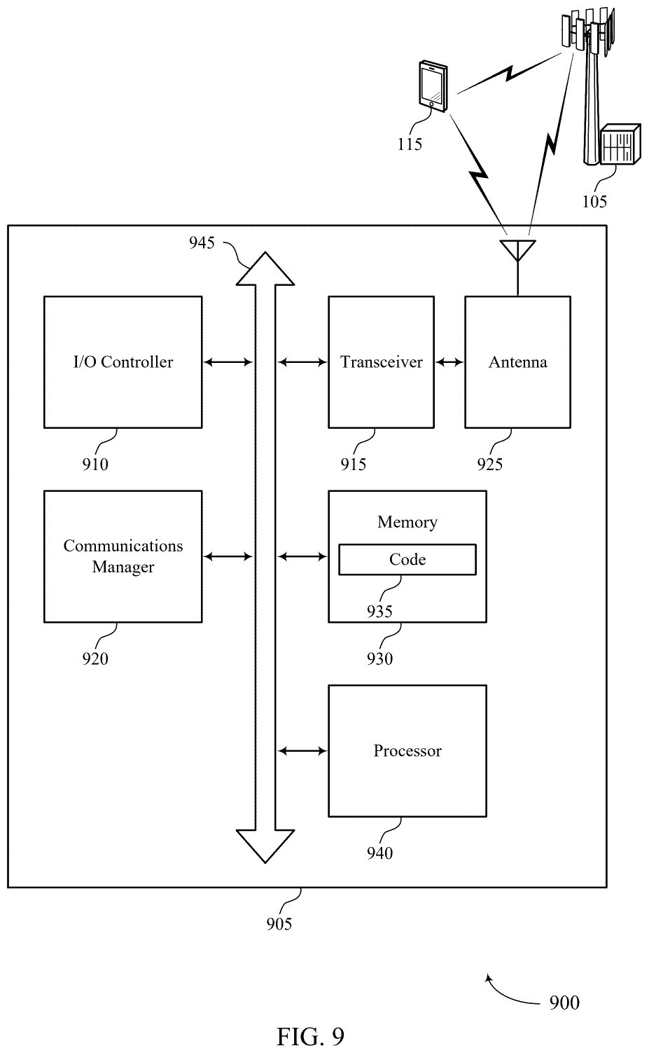

FIG. 9 shows a diagram of a system 900 including a device 905 that supports SBFD for random access and uplink channel occasions in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting SBFD for random access and uplink channel occasions). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving a RACH configuration that indicates a set of ROs and a set of POs. The communications manager 920 is capable of, configured to, or operable to support a means for transmitting a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot. The communications manager 920 is capable of, configured to, or operable to support a means for receiving a second message associated with the two-step random access procedure based on the transmitted first message.

By including or configuring the communications manager 920 in accordance with examples as described herein, the device 905 may support techniques for performing two-step RACH procedures via occasions scheduled for SBFD slots, thereby improving communication efficiency, and reducing potential latencies.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of SBFD for random access and uplink channel occasions as described herein, or the at least one processor 940 and the at least one memory 930 may be otherwise configured to, individually or collectively, perform or support such operations.

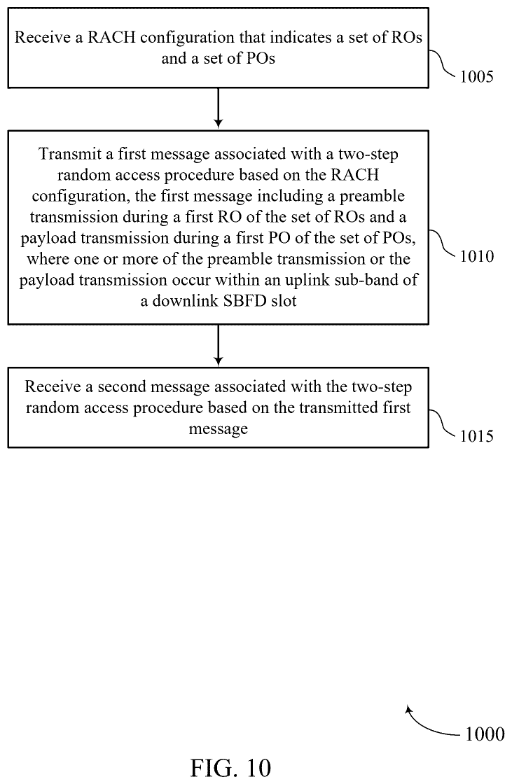

FIG. 10 shows a flowchart illustrating a method 1000 that supports SBFD for random access and uplink channel occasions in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a RACH configuration that indicates a set of ROs and a set of POs. The operations of 1005 may be performed in accordance with examples as disclosed herein. In some examples, aspects of the operations of 1005 may be performed by a configuration component 825 as described with reference to FIG. 8.

At 1010, the method may include transmitting a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot. The operations of 1010 may be performed in accordance with examples as disclosed herein. In some examples, aspects of the operations of 1010 may be performed by a message component 830 as described with reference to FIG. 8.

At 1015, the method may include receiving a second message associated with the two-step random access procedure based on the transmitted first message. The operations of 1015 may be performed in accordance with examples as disclosed herein. In some examples, aspects of the operations of 1015 may be performed by a message manager 835 as described with reference to FIG. 8.

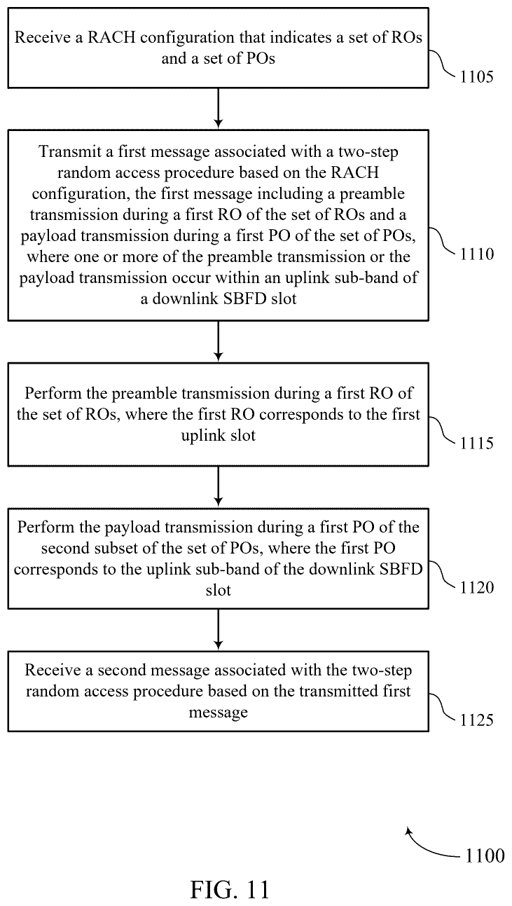

FIG. 11 shows a flowchart illustrating a method 1100 that supports SBFD for random access and uplink channel occasions in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a RACH configuration that indicates a set of ROs and a set of POs. The operations of 1105 may be performed in accordance with examples as disclosed herein. In some examples, aspects of the operations of 1105 may be performed by a configuration component 825 as described with reference to FIG. 8.

At 1110, the method may include transmitting a first message associated with a two-step random access procedure based on the RACH configuration, the first message including a preamble transmission during a first RO of the set of ROs and a payload transmission during a first PO of the set of POs, where one or more of the preamble transmission or the payload transmission occur within an uplink sub-band of a downlink SBFD slot. The operations of 1110 may be performed in accordance with examples as disclosed herein. In some examples, aspects of the operations of 1110 may be performed by a message component 830 as described with reference to FIG. 8.

At 1115, the method may include performing the preamble transmission during a first RO of the set of ROs, where the first RO corresponds to the first uplink slot. The operations of 1115 may be performed in accordance with examples as disclosed herein. In some examples, aspects of the operations of 1115 may be performed by a preamble component 840 as described with reference to FIG. 8.

At 1120, the method may include performing the payload transmission during a first PO of the second subset of the set of POs, where the first PO corresponds to the uplink sub-band of the downlink SBFD slot. The operations of 1120 may be performed in accordance with examples as disclosed herein. In some examples, aspects of the operations of 1120 may be performed by a payload component 845 as described with reference to FIG. 8.

At 1125, the method may include receiving a second message associated with the two-step random access procedure based on the transmitted first message. The operations of 1125 may be performed in accordance with examples as disclosed herein. In some examples, aspects of the operations of 1125 may be performed by a message manager 835 as described with reference to FIG. 8.

The following provides an overview of aspects of the present disclosure:

Aspect 1: A method for wireless communication, comprising: receiving a RACH configuration that indicates a set of ROs and a set of POs; transmitting a first message associated with a two-step random access procedure based at least in part on the RACH configuration, the first message comprising a preamble transmission during a first RO of the set of ROs and a payload transmission during a first PO of the set of POs, wherein one or more of the preamble transmission or the payload transmission occur within an uplink sub-band of a downlink SBFD slot; and receiving a second message associated with the two-step random access procedure based at least in part on the transmitted first message.

Aspect 2: The method of aspect 1, wherein the RACH configuration schedules the set of ROs on a first uplink slot, a first subset of the set of POs on a second uplink slot, and a second subset of the set of POs on the uplink sub-band of the downlink SBFD slot.

Aspect 3: The method of aspect 2, further comprising: performing the preamble transmission during a first RO of the set of ROs, wherein the first RO corresponds to the first uplink slot; and performing the payload transmission during a first PO of the second subset of the set of POs, wherein the first PO corresponds to the uplink sub-band of the downlink SBFD slot.

Aspect 4: The method of aspect 3, further comprising: selecting a preamble from a set of preambles corresponding to the first RO, wherein a first subset of the set of preambles corresponds to the first subset of the set of POs, and a second subset of the set of preambles corresponds to the second subset of the set of POs; and performing the preamble transmission during the first RO based at least in part on the selected preamble.

Aspect 5: The method of any of aspects 2 through 4, further comprising: selecting a preamble from a set of preambles corresponding to the first RO, wherein each preamble of the set of preambles corresponds a respective first PO of the first subset of the set of POs and a second PO of the second subset of the set of POs; performing the preamble transmission during a first RO; and performing the payload transmission during a first PO of the first subset of the set of POs or during a second PO of the second subset of the set of POs based at least in part on selecting the preamble.

Aspect 6: The method of any of aspect 1, wherein the RACH configuration schedules a first subset of the set of ROs on a first uplink slot, a second subset of the set of ROs on the uplink sub-band of the downlink SBFD slot, and the set of POs on a second uplink slot.

Aspect 7: The method of aspect 6, further comprising: performing the preamble transmission during a first RO of the second subset of the set of ROs, wherein the first RO corresponds to the uplink sub-band of the downlink SBFD slot; and performing the payload transmission during a first PO of the set of POs during the second uplink slot.

Aspect 8: The method of aspect 7, further comprising: selecting a preamble from a set of preambles corresponding to the first RO, wherein each preamble of the set of preambles corresponds to a PO of the set of POs; and performing the preamble transmission during the first RO based at least in part on the selected preamble, wherein performing the payload transmission during the first PO is based at least in part on the preamble transmission.

Aspect 9: The method of any of aspects 6 through 8, further comprising: receiving an indication of one or more reference signals corresponding to second subset of the set of ROs, the one or more reference signals indicating a mapping between the second subset of the set of ROs and the set of POs, wherein performing the preamble transmission is based at least in part on the mapping.

Aspect 10: The method of aspect 1, wherein the RACH configuration schedules a first subset of the set of ROs on a first uplink slot, a second subset of the set of ROs on a first uplink sub-band of a first downlink SBFD slot, a first subset of the set of POs on a second uplink slot, and a second subset of the set of POs on a second uplink sub-band of a second downlink SBFD slot.

Aspect 11: The method of aspect 10, wherein the RACH configuration indicates a first mapping between the first subset of the set of ROs and the first subset of the set of POs, and a second mapping between the second subset of the set of ROs and the second subset of the set of POs.

Aspect 12: The method of aspect 11, further comprising: performing the preamble transmission within the first uplink sub-band of the first downlink SBFD slot; and performing the payload transmission within the second uplink sub-band of the second downlink SBFD slot based at least in part on the second mapping.

Aspect 13: The method of aspect 10, wherein the RACH configuration indicates a mapping between the set of ROs and the set of POs.

Aspect 14: The method of aspect 13, further comprising: performing the preamble transmission during the first uplink slot; and performing the payload transmission within the second uplink sub-band of the second downlink SBFD slot based at least in part on the mapping.

Aspect 15: The method of any of aspects 13 through 14, further comprising: performing the preamble transmission within the first uplink sub-band of the first downlink SBFD slot; and performing the payload transmission during the second uplink slot based at least in part on the mapping.

Aspect 16: An apparatus for wireless communication, comprising one or more memories storing processor-executable code, and one or more processors coupled with the one or more memories and individually or collectively operable to execute the code to cause the apparatus to perform a method of any of aspects 1 through 15.

Aspect 17: An apparatus for wireless communication, comprising at least one means for performing a method of any of aspects 1 through 15.

Aspect 18: A non-transitory computer-readable medium storing code for wireless communication, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a random access channel configuration that indicates a set of random access channel occasions and a set of physical uplink shared channel occasions;
transmit a first message associated with a two-step random access procedure based at least in part on the random access channel configuration, the first message comprising a preamble transmission during a first random access channel occasion of the set of random access channel occasions and a payload transmission during a first physical uplink shared channel occasion of the set of physical uplink shared channel occasions, wherein one or more of the preamble transmission or the payload transmission occur within an uplink sub-band of a downlink sub-band full duplex slot; and
receive a second message associated with the two-step random access procedure based at least in part on the transmitted first message.

2. The UE of claim 1, wherein the random access channel configuration schedules the set of random access channel occasions on a first uplink slot, a first subset of the set of physical uplink shared channel occasions on a second uplink slot, and a second subset of the set of physical uplink shared channel occasions on the uplink sub-band of the downlink sub-band full duplex slot.

3. The UE of claim 2, wherein the one or more processors are individually or collectively further operable to execute the code to cause the UE to:
perform the preamble transmission during a first random access channel occasion of the set of random access channel occasions, wherein the first random access channel occasion corresponds to the first uplink slot; and
perform the payload transmission during a first physical uplink shared channel occasion of the second subset of the set of physical uplink shared channel occasions, wherein the first physical uplink shared channel occasion corresponds to the uplink sub-band of the downlink sub-band full duplex slot.

4. The UE of claim 3, wherein the one or more processors are individually or collectively further operable to execute the code to cause the UE to:
select a preamble from a set of preambles corresponding to the first random access channel occasion, wherein a first subset of the set of preambles corresponds to the first subset of the set of physical uplink shared channel occasions, and a second subset of the set of preambles corresponds to the second subset of the set of physical uplink shared channel occasions; and
perform the preamble transmission during the first random access channel occasion based at least in part on the selected preamble.

5. The UE of claim 2, wherein the one or more processors are individually or collectively further operable to execute the code to cause the UE to:
select a preamble from a set of preambles corresponding to the first random access channel occasion, wherein each preamble of the set of preambles corresponds a respective first physical uplink shared channel occasion of the first subset of the set of physical uplink shared channel occasions and a second physical uplink shared channel occasion of the second subset of the set of physical uplink shared channel occasions;
perform the preamble transmission during a first random access channel occasion; and
perform the payload transmission during a first physical uplink shared channel occasion of the first subset of the set of physical uplink shared channel occasions or during a second physical uplink shared channel occasion of the second subset of the set of physical uplink shared channel occasions based at least in part on selecting the preamble.

6. The UE of claim 1, wherein the random access channel configuration schedules a first subset of the set of random access channel occasions on a first uplink slot, a second subset of the set of random access channel occasions on the uplink sub-band of the downlink sub-band full duplex slot, and the set of physical uplink shared channel occasions on a second uplink slot.

7. The UE of claim 6, wherein the one or more processors are individually or collectively further operable to execute the code to cause the UE to:
perform the preamble transmission during a first random access channel occasion of the second subset of the set of random access channel occasions, wherein the first random access channel occasion corresponds to the uplink sub-band of the downlink sub-band full duplex slot; and
perform the payload transmission during a first physical uplink shared channel occasion of the set of physical uplink shared channel occasions during the second uplink slot.

8. The UE of claim 7, wherein the one or more processors are individually or collectively further operable to execute the code to cause the UE to:
select a preamble from a set of preambles corresponding to the first random access channel occasion, wherein each preamble of the set of preambles corresponds to a physical uplink shared channel occasion of the set of physical uplink shared channel occasions; and
perform the preamble transmission during the first random access channel occasion based at least in part on the selected preamble,
wherein the payload transmission is performed during the first physical uplink shared channel occasion based at least in part on the preamble transmission.

9. The UE of claim 6, wherein the one or more processors are individually or collectively further operable to execute the code to cause the UE to:
receive an indication of one or more reference signals corresponding to second subset of the set of random access channel occasions, the one or more reference signals indicating a mapping between the second subset of the set of random access channel occasions and the set of physical uplink shared channel occasions,
wherein the preamble transmission is performed based at least in part on the mapping.

10. The UE of claim 1, wherein the random access channel configuration schedules a first subset of the set of random access channel occasions on a first uplink slot, a second subset of the set of random access channel occasions on a first uplink sub-band of a first downlink sub-band full duplex slot, a first subset of the set of physical uplink shared channel occasions on a second uplink slot, and a second subset of the set of physical uplink shared channel occasions on a second uplink sub-band of a second downlink sub-band full duplex slot.

11. The UE of claim 10, wherein the random access channel configuration indicates a first mapping between the first subset of the set of random access channel occasions and the first subset of the set of physical uplink shared channel occasions, and a second mapping between the second subset of the set of random access channel occasions and the second subset of the set of physical uplink shared channel occasions.

12. The UE of claim 11, wherein the one or more processors are individually or collectively further operable to execute the code to cause the UE to:
perform the preamble transmission within the first uplink sub-band of the first downlink sub-band full duplex slot; and
perform the payload transmission within the second uplink sub-band of the second downlink sub-band full duplex slot based at least in part on the second mapping.

13. The UE of claim 10, wherein the random access channel configuration indicates a mapping between the set of random access channel occasions and the set of physical uplink shared channel occasions.

14. The UE of claim 13, wherein the one or more processors are individually or collectively further operable to execute the code to cause the UE to:
perform the preamble transmission during the first uplink slot; and
perform the payload transmission within the second uplink sub-band of the second downlink sub-band full duplex slot based at least in part on the mapping.

15. The UE of claim 13, wherein the one or more processors are individually or collectively further operable to execute the code to cause the UE to:
perform the preamble transmission within the first uplink sub-band of the first downlink sub-band full duplex slot; and
perform the payload transmission during the second uplink slot based at least in part on the mapping.

16. A method for wireless communication, comprising:
receiving a random access channel configuration that indicates a set of random access channel occasions and a set of physical uplink shared channel occasions;
transmitting a first message associated with a two-step random access procedure based at least in part on the random access channel configuration, the first message comprising a preamble transmission during a first random access channel occasion of the set of random access channel occasions and a payload transmission during a first physical uplink shared channel occasion of the set of physical uplink shared channel occasions, wherein one or more of the preamble transmission or the payload transmission occur within an uplink sub-band of a downlink sub-band full duplex slot; and
receiving a second message associated with the two-step random access procedure based at least in part on the transmitted first message.

17. The method of claim 16, wherein the random access channel configuration schedules the set of random access channel occasions on a first uplink slot, a first subset of the set of physical uplink shared channel occasions on a second uplink slot, and a second subset of the set of physical uplink shared channel occasions on the uplink sub-band of the downlink sub-band full duplex slot.

18. The method of claim 17, further comprising:
performing the preamble transmission during a first random access channel occasion of the set of random access channel occasions, wherein the first random access channel occasion corresponds to the first uplink slot; and
performing the payload transmission during a first physical uplink shared channel occasion of the second subset of the set of physical uplink shared channel occasions, wherein the first physical uplink shared channel occasion corresponds to the uplink sub-band of the downlink sub-band full duplex slot.

19. The method of claim 18, further comprising:
selecting a preamble from a set of preambles corresponding to the first random access channel occasion, wherein a first subset of the set of preambles corresponds to the first subset of the set of physical uplink shared channel occasions, and a second subset of the set of preambles corresponds to the second subset of the set of physical uplink shared channel occasions; and
performing the preamble transmission during the first random access channel occasion based at least in part on the selected preamble.

20. A non-transitory computer-readable medium storing code for wireless communication, the code comprising instructions executable by one or more processors to:
receive a random access channel configuration that indicates a set of random access channel occasions and a set of physical uplink shared channel occasions;
transmit a first message associated with a two-step random access procedure based at least in part on the random access channel configuration, the first message comprising a preamble transmission during a first random access channel occasion of the set of random access channel occasions and a payload transmission during a first physical uplink shared channel occasion of the set of physical uplink shared channel occasions, wherein one or more of the preamble transmission or the payload transmission occur within an uplink sub-band of a downlink sub-band full duplex slot; and
receive a second message associated with the two-step random access procedure based at least in part on the transmitted first message.
